(19) United States
(12) Patent Application Publication
(10) Pub. No.: US 2026/0064567 A1
(43) Pub. Date: Mar. 5, 2026

(54) SYSTEM AND METHOD FOR GRAPH-AUGMENTED TEST CASE GENERATION USING ARTIFICIAL INTELLIGENCE (AI)

(71) Applicant: ACCENTURE GLOBAL SOLUTIONS LIMITED, Dublin 4 (IE)

(72) Inventors: Yao Yang, Sunnyvale, CA (US); Keyu Qi, Dongguan (CN); Wenjun Luo, Shenzhen (CN); Jintao Ling, Shenzhen (CN)

(73) Assignee: ACCENTURE GLOBAL SOLUTIONS LIMITED, Dublin 4 (IE)

(21) Appl. No.: 18/821,361

(22) Filed: Aug. 30, 2024

(51) Int. Cl. G06F 11/36

(52) U.S. Cl. CPC G06F 11/3684

(57) ABSTRACT

The present disclosure relates to a technique for addressing an issue to be resolved associated with an electronic document. The method discloses accessing an actionable portion associated with a particular knowledge domain of the electronic document and associated context. Further, retrieve data from data sources to provide additional information related to the particular knowledge domain and the associated context. Then structuring the retrieved data to produce a subset of organized data and determine the issue to be resolved related to the electronic document. Further, generate data elements associated with the issue to be resolved and map dependency relationships between data elements. Also, determine test goals associated with the issue to be resolved based on the dependency relationships. Thereafter, determine corresponding test cases associated with resolution and determines actionable test steps related to the issue to be resolved based on the corresponding test cases associated with the electronic document.

### FIELD OF THE INVENTION

Various embodiments described herein generally relate to an issue associated with an electronic document. More specifically, the present disclosure relates a method and a system for addressing an issue to be resolved associated with the electronic document.

### BACKGROUND

Generative Artificial Intelligence (Gen AI) models, for example Large Language Models (LLMs) are advanced AI systems designed to understand and generate human language. These models are typically trained on vast amounts of text data, enabling them to perform a wide range of natural language processing (NLP) tasks. LLMs use a neural network architecture known as transformers. Transformers are particularly effective for NLP tasks because they can process and generate text by considering the context of the entire input sequence. This allows LLMs to generate coherent and contextually appropriate responses.

### SUMMARY

Implementations of the present disclosure are generally directed to an issue associated with an electronic document. More specifically, the present disclosure relates a method and a system for addressing an issue to be resolved associated with the electronic document.

According to an embodiment of the invention, a method is disclosed for addressing an issue to be resolved associated with an electronic document. The method discloses to access an actionable portion associated with a particular knowledge domain of the electronic document and associating a context with the actionable portion. Further, retrieve data from data sources to provide additional information related to the particular knowledge domain and the associated context. Then structuring the retrieved data to produce a subset of organized data related to the associated context. Thereafter, the method determines the issue to be resolved related to the electronic document based on the subset of organized data. Generates data elements associated with the issue to be resolved based on the subset of organized data. Further, map dependency relationships between the one or more data elements associated with the issue to be resolved. The method also discloses to determine test goals associated with the issue to be resolved based on the dependency relationships. Further, determine corresponding test cases associated with resolution of the issue to be resolved. Thereafter, the method discloses to determine actionable test steps related to the issue to be resolved based on the corresponding test cases, so that the actionable test steps are associated with the electronic document.

The present disclosure further describes a system for implementing the method provided herein. The present disclosure also describes computer-readable media storing instructions couple to one or more processors and having instructions stored thereon which, when executed by the one or more processors, cause the one or more processors to perform operations in accordance with the method described herein.

It is appreciated that system in accordance with the present disclosure can include any combination of the aspects and features described herein. That is, the non-transitory, computer-readable medium including machine-readable instructions in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various embodiments in accordance with the present disclosure will be described with reference to the drawings, in which:

FIG. 1 illustrates an example environment that may be used to execute implementations of the present disclosure.

FIG. 2 illustrates an exemplary block diagram of a system, in accordance with the present disclosure.

FIG. 3A illustrates an example disclosing pre-processing and processing of input data provided to the system, in accordance with the present disclosure.

FIG. 3B illustrates generation of the knowledge graph based on the pre-processed data and FIG. 3C discloses an example disclosing the post-processing of processed data to merge redundant test scenarios into a new scenario, in accordance with the present disclosure

FIG. 4 illustrates an exemplary merging process for redundant nodes, in accordance with the present disclosure.

FIG. 5 illustrates a block diagram of a Retrieval-Augmented Generation (RAG) technique for Gen AI model, in accordance with the present disclosure.

FIG. 6 illustrates an exemplary flow diagram for addressing an issue to be resolved associated with an electronic document, in accordance with present disclosure.

FIG. 7 illustrates a computer system 700 used for addressing an issue to be resolved associated with an electronic document.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

References to one or an embodiment in the present disclosure can be, but not necessarily are, references to the same embodiment; and such references mean at least one of the embodiments.

Reference to any “example” herein (e.g., “for example”, “an example of”, by way of example” or the like) are to be considered non-limiting examples regardless of whether expressly stated or not.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but no other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Several definitions that apply throughout this disclosure will now be presented. The term “learning model” is defined to be essentially conforming to the particular dimension, shape, or other feature that the term modifies, such that the component need not be exact. For example, “graph may be defined as knowledge graph, sanitized may be defined as redacted, filler information may be defined as fake value or fake information and confidential may be defined as restricted.

The term “comprising” when utilized means “including, but not necessarily limited to”; it specifically indicates open-ended inclusion or membership in the so-described combination, group, series and the like.

The term “a” means “one or more” unless the context clearly indicates a single element.

The term “about” when used in connection with a numerical value means a variation consistent with the range of error in equipment used to measure the values, for which ±5% may be expected. Non-numerical uses of “about” carry similar variation.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

“Discrete chunks” of text refer to a subset of words from the text. A non-limiting example of discrete chunks of text are discrete sentences found within the text, or a discrete portion of a sentence found within the text. Preferably discrete chunks do not overlap, although the invention is not so limited, and overlap may be present.

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures and techniques may be shown without unnecessary detail in order to avoid obscuring example embodiments.

The specification and drawings are to be regarded in an illustrative rather than a restrictive sense. It will, however, be evident that various modifications and changes may be made there onto without departing from the broader spirit and scope of the invention as set forth in the claims.

For simplicity and illustrative purposes, the present disclosure is described by referring mainly to examples thereof. The examples of the present disclosure described herein may be used together in different combinations. In the following description, details are set forth in order to provide some examples that may be considered in at least one of the following ways in the present disclosure.

Industries across the board face challenges to directly use Gen AI techniques to generate test cases which in existing art led to incomplete coverage and inaccurate outcome. Some of the challenges faced by Gen AI based test case generation are complexity of UI elements, dynamic content, state management, edge cases, context awareness, performance, validation and accuracy and integration with existing tools due to which the output cannot be directly used by quality analysts (QA). Gen AI models lack QA's specific domain knowledge, leading to a gap between test case output and QA's standards (for example but not limited to redundancy). For example, modern UIs can be very complex, with nested elements and dynamic content. Accurately interpreting these elements and their states can be difficult. Moreover, ensuring that the Gen AI models understand the different states of the UI and how transition between states occur is crucial for generating accurate test cases. Therefore, there is a need to develop technique for providing information to Gen AI models in a comprehend manner and to increase input relevancy at each step, thereby reducing redundancy in the output. Accordingly, there is a need to solve complete test case coverage, inaccurate and unspecific problems and to directly use Gen AI models to generate test cases.

The present disclosure discloses a Gen AI powered model to efficiently generate testcases from flat data, such as but not limited to user interface (UI). It also helps to reduce redundancy that saves computer resources, storage and generate output more efficiently. The present disclosure therefore discloses system and method to receive raw data, pre-process the raw data to represent complex elements and their intrinsic relationship. Thereafter, the pre-processed data is further processed to guide Gen AI based model to evaluate results in required format and to avoid data overloading. Finally, the step of post processing eliminate redundancy from output.

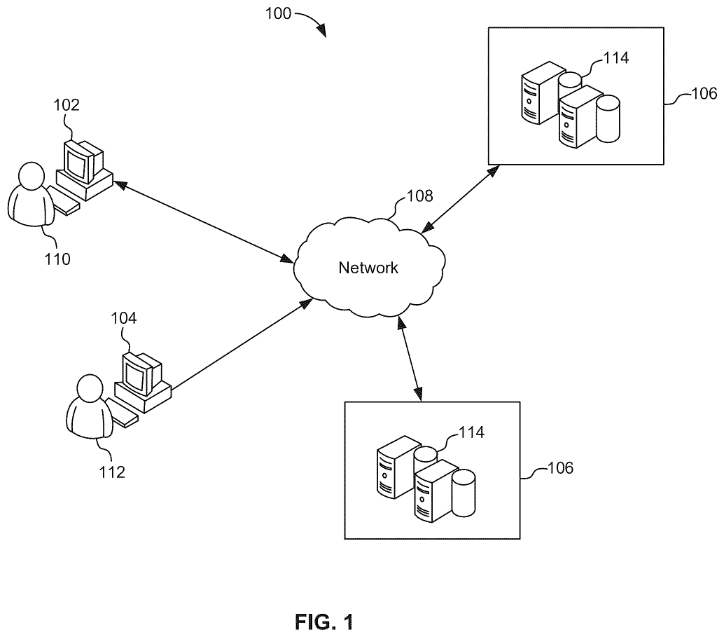

FIG. 1 illustrates an environment of a system in accordance with some implementations of the present disclosure. System 100 includes numerous elements for purposes of illustration rather than limitation. It may be noted that system 100 may include the same, more, or fewer elements configured in the same or different manner in other implementations.

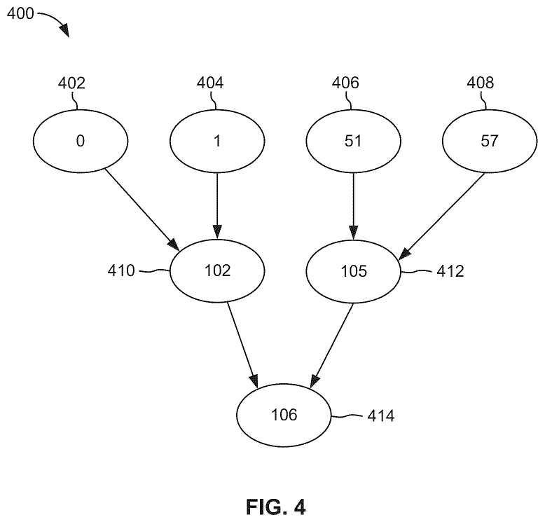

System 100 includes several computing devices 102-108. The computing devices 102-108 may be embodied, for example, desktop computing devices, smartphones, laptops, tablet, voice-enabled devices, a workstation, a personal computer, a notebook, and/or the like. In some examples, the computing devices 102-108 are used by respective users 402 (disclosed in FIG. 4) to log into and interact with computing platforms executing applications according to implementations of the present disclosure. The network connects websites, the computing devices 102-108, and the back-end systems like data storage 126, storage units 134 and/or 144 (data storage 126 and storage units 134 144 may interchangeably be referred to as back-end systems). The storage unit 134 may further include neural cache arrays 136 to 142, for example, which may for simplicity be represented as storage 1, storage 2, storage 3 and storage 4. The storage units 144 may further include neural cache arrays 146 to 152, for example, which may for simplicity be represented as storage 1, storage 2, storage 3 and storage 4. The computing devices 102-108 may have several computing applications installed on the computing devices to perform various functions. These applications interact with the system 100 components using an API layer 112. The API layer 112 acts as a bridge between the applications in computing devices and underlying system 100. The primary function of the API layer 112 may be to provide an interface for API calls and requests. By seamlessly integrating, communicating, and sharing data and functionalities via APIs, the API layer enables efficient interaction between the applications in computing devices 102-108 and the storage units 134, 144.

In some examples, a network that supports interaction/communication between the computing devices and other components of the system 100, may include but not limited to a Local Area Network (LAN), a Wide Area Network (WAN), Internet, or a combination thereof. In some examples, the network of the system 100 may be accessed over a wired and/or a wireless communication link. For example, a computing device like smartphone may utilize a cellular network to access the network 108.

In some examples, one or more of the back-end systems 126, 134, 144 may be implemented as an on-premises system that is operated by an enterprise or a third-party engaged in cross-platform interactions and data management. In some examples, the back-end systems 126, 134, 144 may be implemented as an off-premises system (for example, cloud or on-demand) that is operated by an enterprise or a third-party on behalf of an enterprise. In some examples, the back-end systems 126, 134, 144 may be implemented in a cloud environment. For simplicity, the back-end systems 134 and 144 depicted in FIG. 1 may be a cloud environment that is intended to represent various forms of servers including a web server, an application server, a proxy server, a network server, a server pool, and/or the like. The storage unit 1, 134 may further disclose various storages, for example but not limited to SharePoint, Documentum, AWS S3, Dropbox and so on. The storage unit 2, 144 may further disclose various storages, for example but not limited to SharePoint, Azure Blobs, GCP Buckets, File System and so on. Further, the back-end system 126, which may be exemplary illustrated as data storage 126, may be a centralized storage system or master storage that manages and stores data for applications, websites, or services. For example—the data storage 126 can be a central database that is capable of storing indexes, metadata (json or xml) and/or data in relational form. The data storage 126 may further include an index store 128, a metadata 130 and a data store 132. The index store 128 (interchangeably referred to as index structure) stores (key, value) pairs or particulars, sometimes referred to as a dictionary/map/items. The primary function of the index store is to efficiently access a given record based on a particular field. Accordingly, instead of scanning through the entire collection, the index store 128 searches the desired record in the index. The metadata 130 includes attributes like file creation time, file type, size, modification history and so on. Such details help to manage and organize data effectively. The data store 132 is a temporary storage in the data storage 126.

In some examples, each of the back-end systems 126, 134 and 144 are coupled to one or more processors 114. The processor 114 may host components of enterprise systems and applications. Also, the processor 114 accepts requests from the computing devices 102-108 for services being provided by the enterprise systems and the applications. In response to the accepted requests, the processor 114 provides the requested services to the computing devices 102-108 over the network. The requests received from the computing devices 102-108 may be text prompts. The text prompts may be used as a mode of interaction with a Machine Learning (ML) system or a neural network. In some examples, the GAI system may be implemented by the enterprise systems for generating responses/outputs for the text prompts or for performing one or more specified tasks in response to the text prompts. Examples of the tasks may include question-answers, data analysis, searching from the database and/or the like.

The processor 114 provide services for the back-end systems 126, 134, 144, that may include multiple components but are not limited to a search block 118, a file versioning block 122, a virus scan block 120, an audit logging block 124 and so on. The search block 118 searches a file requested by the computing devices. The virus scan block 120 scans all input files received from the computing system 1, computing system 2, computing system 3 and computing system 4, 102-108 for any risks or viruses before storing the received file into the backend systems. The file versioning block 122 stores different versions of files that are made over the time due to changes in the file or the formats of the file. The audit logging block 124 systematically record events, actions, and changes within a computer system, network, application, or database. These recorded events are stored in a structured and chronologically ordered format within files or databases known as audit logs. The audit logs may contain one or more of timestamp, event description and tags, users and entities, action types of data access details, error information, transaction details, and so on. The processor 114 may be coupled to a storage wrapper 116. The storage wrapper 116 simplify the usage of complex or low-level functionality by offering a higher-level, user-friendly interface. They abstract away underlying complexity, providing consistent methods or classes that developers can easily understand and utilize. The API layer 112, the processor 114, the storage wrapper 116 and may include further components that together discloses neural network based data storage 110.

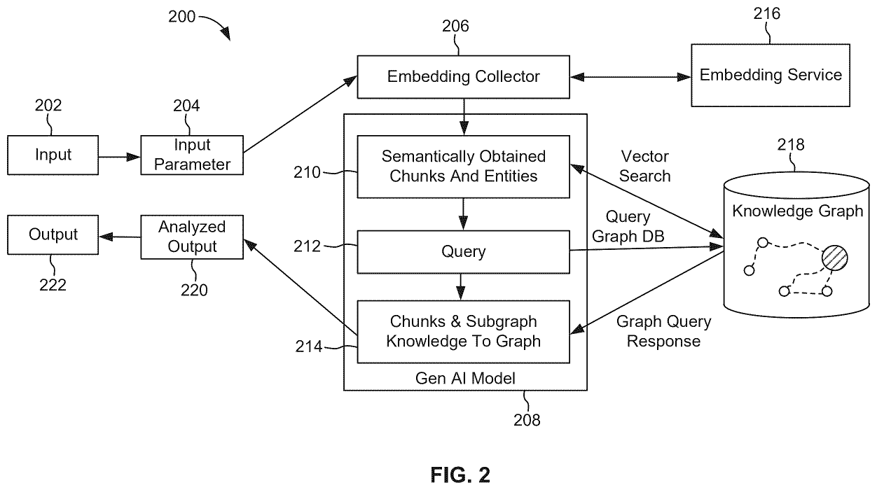

FIG. 2 illustrates an exemplary block diagram of a system 200, in accordance with the present disclosure.

The system 200 discloses an input block 202 to receive input, an input parameter block 204, an embedding collector 206, a Gen AI model 208 including a semantically obtained chunks and entities block 210, a query block 212, and a chunks and subgraph block 214. The system further discloses an embedding service block 216 and a knowledge graph 218.

The input block 202 receives the input, for example, the input may be received from the user interface UI (UI). The UI discloses flat data, which needs preprocessing. The UI may be considered as an electronic document on which preprocessing is performed to fetch input parameters at block 204. It is then required to assess an actionable portion of the electronic document which is associated with the particular knowledge domain. Thereafter, context is associated with the actionable portion of the electronic document. The actionable portion in the electronic document may be considered as the portion or the button or the information on which the action is required to be performed. For example, if the electronic document may be considered as the user interface (UI), in which a user logs in a complaint. Then, the complaint may be considered as the actionable portion of the electronic document/user interface. Thus, pre-processing the input data for the electronic document is required to perform action on the actionable portion of the electronic document.

The pre-processing of the input may include, for example but not limited to, receiving a manual input in the form of flat data (FD). The manual input may be received at the UI in accordance with the user requirement. Input as the function design information may be logged in as a rewrite file, which may further be rewrite in FD doc, for example but not limited to a table, text, etc. The rewrite FD doc further output the reformatted information. The input reformatted function design information may be provided to the file that stores dependency with prompt. Thereafter, output the dependency relationship between UI elements and saved the output into a file that stores dependency. For example, “[search button] depends on [age textfield]”, indicating that the user clicks the search button to search events based on the input age. Thereafter, processing may be performed to generate test goals for each dependency relationship in the file that stores dependency. The test files that stores dependency and determine dependency relationship between UI elements in the file that stores dependency. Thereafter the dependency data may be processed further.

The processing of retrieved data from one or more data sources provides additional information related to the particular knowledge domain and the associated context. The data sources include PRDs, functional design documents, user needs description documents, and workflow descriptions. Thereafter, structure the retrieved data from the one or more data sources to produce a subset of organized data related to the associated context. The system 200 further discloses to determine, based on the subset of organized data, an issue to be resolved related to the electronic document. Further, based on the subset of organized data associated with the issue to be resolved, generates one or more data elements associated with the issue to be resolved. Thereafter, map one or more dependency relationships between the one or more data elements associated with the issue to be resolved. Further, on the basis of the dependency relationship, the test goals are determined associated with the issue to be resolved. Now, based on the determined test goals, determine corresponding test cases associated with resolution of the issue to be resolved. Accordingly, based on the corresponding test cases, one or more actionable test steps related to the issue to be resolved are determined, so that the one or more actionable test steps are associated with the electronic document.

Further, determining, based on a calculated distance between a vector representation of a first one of the one or more of the actionable test steps and a vector representation of a second one of the one or more of the actionable test steps, that the first one of the one or more of the actionable test steps and the second one of the one or more actionable test steps exceeds a similarity threshold, wherein the exceeding of the similarity threshold indicates a likelihood of redundancy.

During processing, different files may generate. Based on the file that stores dependency in pre-processing, a test file that stores goal may generate which in turn generates a file that stores generated goals. It may be further processed to generate scenarios in file and a Test scenarios file. Inputs from the Test scenarios file may be sent for post-processing to generate a Got file. The Got file may be processed to generate a Processed revised scenario file. Thereafter, the inputs from the Test scenarios file and the revised Processed scenario file may be provided further for processing to generate a Test step file. The test file that stores step is then processed to finally result in a final test step test step file generation.

During processing embeddings may be generated and stored in embedding service 216. The embeddings are numerical representations of data (like words, sentences, or entities) in a continuous vector space. These embeddings capture semantic meaning, allowing similar items to be placed closer together in this space. The embeddings may then be collected at the embedding collector 206. Further, vectors are the actual numerical arrays that represent embeddings. In a vector space, each dimension captures some aspect of the data's meaning. Vectors are used in vector search to find the most relevant chunks of data and entities based on their proximity to the query vector and processed to generate vectors that represent text segments corresponding to semantically arranged text in vector space. These N semantically related chunks and entities may be received from the knowledge graph during vector search at Semantically obtained chunks and entities 210. The vector space may be defined by the dimensions and values of the embedding vectors. The documents (PRD, FD, UI, workflow, interim results) may be constructed into the knowledge graph to stored information in a structured way. The information reformatted in a structured way and stored in the knowledge graph 218, which the Gen AI model 208 requires being most sensitive to learning. Further, in each generation, graph RAG may be used to feed Gen AI model 218 with the most relevant data. So, the model can get the precise information to help generate the most optimal result.

The system 200 discloses query block 212 that receives a query made by the user and converts this query into embedding. The query block 212 then queries the knowledge graph 218. The embedding may be used to search a vector database in the knowledge graph 218 to find the most relevant chunks of data. The chunk and subgraph knowledge to graph 214 receives the graph query response from the knowledge graph 218. The retrieved chunks can be further enriched by traversing a knowledge graph to provide additional context and relationships. The Gen AI 208 uses this enriched information to generate a more accurate and contextually relevant response. Thereafter, response transmits to analyzed block 220 for further analysis. Thus, the output 222 is generated, for example as actionable test steps according to results of the implementation of the testing scenario.

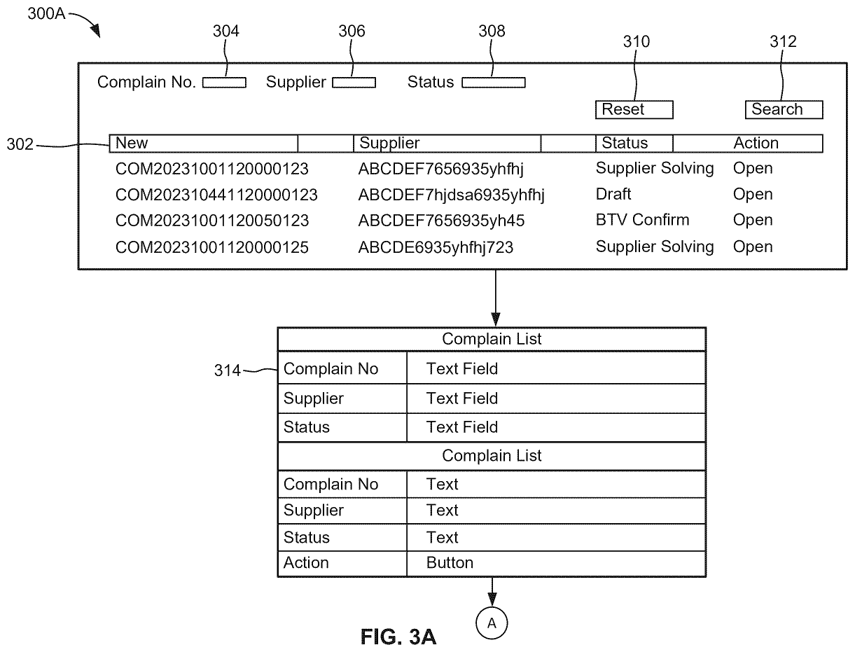

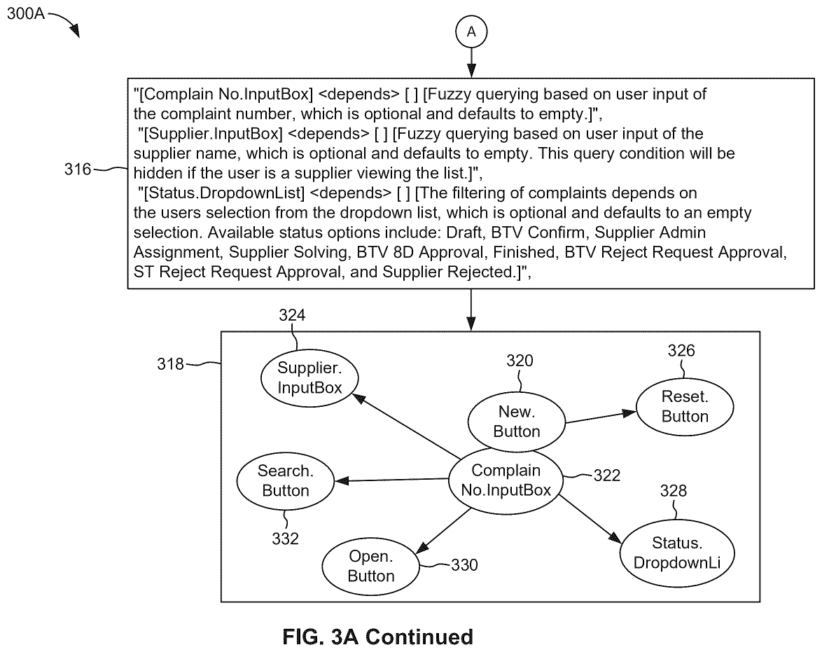

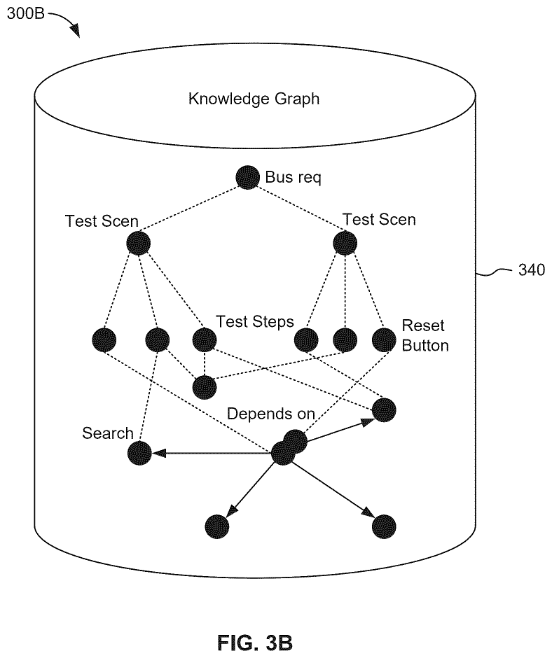

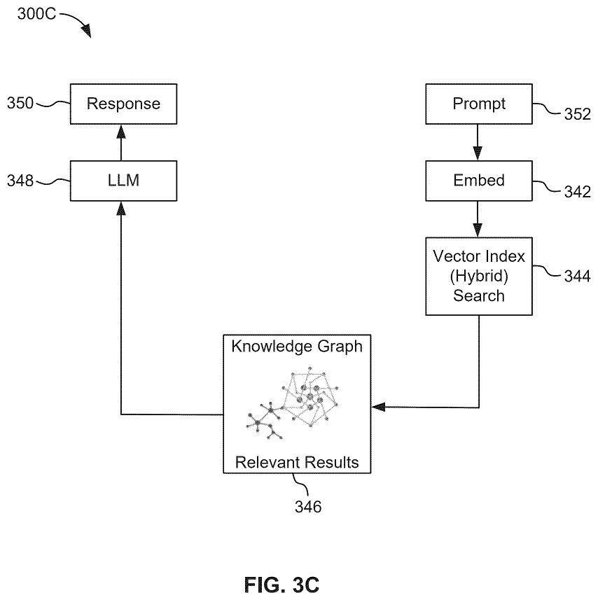

FIG. 3A illustrates an example disclosing pre-processing and processing of input data provided to the system 200, in accordance with the present disclosure.

FIG. 3A discloses pre-processing step 300A for a knowledge graph to provide web information intrinsic logic and dependency. As an example, a test case generation scenario is disclosed herein disclosing input data in different formats to be successfully processed by Gen AI model disclosed in system 200.

For example, a manual input in the form of FD document contains flat information that is provided to the Ge AI model 208. The input information may be provided to a user interface (UI) to register a complaint. The UI discloses different tabs/buttons to enter input data as complaint number 304, supplier 306, status 308, reset 310, search 312, table 302 and so on. In an exemplary embodiment, a user wants to register a complaint in which user enters details regarding complaint in the UI 300A. The details disclosed by the UI (interchangeably be referred to as electronic document) may include complaint number, supplier name, status of the complaint, actions and so on. In the electronic document/UI, an actionable portion may be determined which is associated with the particular knowledge domain. The complaint number 304 as actionable portion may be associated with context such as supplier, status, action and so on in the UI. Thereafter the actionable portion may be regenerated in the form of a table 302 disclosing the latest complaint at the top along with the supplier name status of the complaint being registered and the actions performed. The additional information related to particular knowledge domain and associated context may be retrieved from one or more data sources to support the information. The table 302 may be considered as structuring the retrieved data from different data sources to produce a subset of organised data related to the associated context. Further, based on this subset of organised data, i.e.—complaint list table 302, determine an issue to be resolved in the table. For example, the complaint that is required to be resolved. The complaint registered in table 302 a may be transferred in a structured organized format in table 314. Thereafter, based on the subset of organised data associated with the issue to be resolved generate one or more data elements associated with the issue to be resolved as disclosed in 316. Accordingly, map 318 one or more dependency relationships between the one or more data elements associated with the issue to be resolved. This is pre-processing of the input information to reformat to generate it as structured information to be provided to Gen AI model 208.

The different elements in 300 may be defined as part of input pre-processing process. This may include generation of file, which can be in the form of a table, text, etc. In an example, the query conditions area in UI may be disclosed as one or more of the following:
Complain No.: Users can enter the complaint number for fuzzy querying, which is optional and defaults to blank.
Supplier: Users can input the supplier's name for a fuzzy search, which is also optional and defaults to blank. If the user is a supplier viewing the list, this query condition will be hidden.
Status: Users can select the status of complaints through a dropdown list for filtering purposes, which is not mandatory and defaults to blank. Status options include Draft, BTV Confirm, Supplier Admin Assignment, Supplier Solving, BTV 8D Approval, Finished, BTV Reject Request Approval, ST Reject Request Approval, and Supplier Rejected.

In list area, complaint list may be displayed as follows:
Complain No.: Displays the complaint numbers sorted in reverse chronological order, with the newest created complaints at the top.
Supplier: Displays the name of the supplier associated with the complaint, referring to the suppliers [Company Name].
Status: Displays the current status of the complaint.
Action: Each row features an “Open” button. By clicking on the open button, it opens the detailed page for that particular complaint.

The different button areas in the UI may be disclosed as follows:
Search: Clicking search button, updates the list data based on the filtering conditions set in the query conditions area.
Reset: Clicking resent button, resets the filtering conditions and refreshes the list information.
New: Clicking new button, creates a new complaint and opens its detail page.

This UI interface primarily serves for users to view and manage complaints. Users can query and filter complaints based on different conditions, view detailed information about complaints, create new complaints, and perform various operations on existing ones.

Thereafter, the system 200 input the reformatted function design information to the file that stores dependency with following disclosed prompt. It is considered that the UI design information is already known. Now, based on the existing dependency relationship among UI elements where Element 1s action execution depends on the state, input, or actions of Element 2, is represented as follow:
Task: Based on the provided UI design details, extract all dependency relationships between UI elements. For each group of dependencies, please output: [Element1·Element Type] depends on [Element2·Element Type, Element3·Element Type, . . . ] defining detailed description of the dependency relationship.
Output format: Directly outputs each complete dependency relationship using the dependency tag.

Thereafter, output the dependency relationship between UI elements and saved the output into the file that stores dependency. For instance, “[search button] depends [age textfield]”, indicates that the user clicks the search button to search events based on the input age.

Once the pre-processed output is generated, the next step is to process the received data to generate the test goals for each dependency relationship. This includes assessing each test goal, retrieve all elements information that is relevant to each test goal separately, and input the dependency relationship and corresponding UI element information into the LLM to generate test goals with prompt. Accordingly, output all the dependencies and corresponding test goals.

The different dependencies and test goals may be one or more of the following:
The system should accept empty input and display all complaint records or default search results.
The system should perform fuzzy search based on the entered supplier names and display matching supplier lists
The system should display complaint records that match the selected status.
Complain List Table displays all complaint information matching the input complaint number and sorts it in reverse chronological order by creation time, with the most recently created complaints at the top. The complaint information may match the input supplier name, selected status and so on.
The filter conditions in the query condition area are initialized to empty and complain list table displays all complaint information sorted in reverse chronological order by creation time, with the most recently created complaints at the top.

Further, each row has an Open button, which when clicked, opens the complaint details page. The Open button should exhibit normal clickability with appropriate feedback. Upon clicking the Open button, the system should navigate to the complaint details page corresponding to the row where the button is located.

The system 200 further discloses using test scenario, generate test goals for each test goal in the corresponding goals file. To generate test goals, visit each test goal, use retrieve element file to retrieve all the element information relevant to each test goal separately and input the test goal and corresponding UI element information into the Gen AI model 208 to generate test scenario. In this, the FIG. 3A discloses to provided UI interface elements and functional features to construct various scenarios for the given testing objectives. When designing testing scenarios, it is ensured that each scenario is closely aligned and does not exceed the given testing objectives. Limiting the number of testing scenarios to ensure that each scenario accurately focuses on key aspects of the testing objectives, avoid redundant or overly complex situations. In an example, a structure of each testing scenario may be disclosed as:
“Scene Name”: “Choose a concise and descriptive name for the scene.”,
“Scene scope”: “Describe the functions and UI elements covered by the scene.”,
“Scene description”: “Provide a high-level textual description of the scene, including the main operations and business processes involved in the scene.”,
“Expected results”: “Expected test results for this scenario”,

Thereafter, test objective is defined, UI elements related to test objective are fetched and design various testing scenarios for the testing objectives describing each testing scenario according to the above structure, and package them with tags. No extra information is added. Further, output all the dependencies and corresponding test goals into the file that stores generated goals.

FIG. 3B illustrates generation of the knowledge graph based on the pre-processed data and FIG. 3C discloses an example disclosing the post-processing of processed data to merge redundant test scenarios into a new scenario, in accordance with the present disclosure.

FIGS. 3B and 3C discloses generation of the knowledge graph 340 generated from the processed data. During post processing, convert all test scenarios into a vectorize embedding 342 separately using an embedded model. A vector index 344 may be prepared based on search, such as but not limited to hybrid search. Further, construct a distance graph among all vectorize embeddings 342 where each test scenario may be considered as a node to the knowledge graph 340, 346. Once the nodes are determined, find out two nodes with the smallest distance and merge them using the Gen AI model 208, for example LLM 348 based on the generated prompt 352. Convert the new test scenario into a vectorized embedding and insert into the knowledge graph 346 by updating the distance between the nodes. These steps may be repeated until the distance of nearest nodes add more than the distance threshold. Output all nodes in the knowledge graph 346 into a tree node file and apply merge scenarios to merge redundant nodes together to generate a new node. Accordingly, results in a virtualised merge process to generate response 350 with merged redundant nodes. The response 350 may be generated by disclosing running test step file to generate test step file for test scenarios. The test scenarios may be generated by going through each test goal and retrieving information related to each element that is relevant to each test scenario separately. Thereafter, input the test scenario and corresponding UI element information into the knowledge graph 346 to generate test steps using the prompt 352.

FIG. 4 illustrates an exemplary merging process for redundant nodes, in accordance with the present disclosure.

FIG. 4 discloses a process 400 of merging the two independent test scenarios into a more comprehensive test case. Initially the analysis of two independent test scenarios is performed carefully to understand the testing requirements. For example, let us consider nodes 402 and 404. If the nodes 402 and 404 have commonalities and have similar goals between the respective test scenarios, integrate and rewrite two new testing scenarios for nodes 402 and 404. While writing the new testing scenarios, it is ensured that the sequence of testing steps is correct and does not cause logical conflicts. Thereafter, simplify the scenario by checking if there are similar or redundant steps that can be simplified or removed. Further, ensure that the scene remains complete and accurate. Thereafter review the new testing scenarios and analyse that in the entire scene, there are no omissions or errors and merging the two new scenarios completely to generate a new node 410.

The process defined for nodes 402 and 404 is similarly repeated for the nodes 406 and 408 to generate a merged node 412. On generation of the new nodes 410 and 412, the nodes 410 and 412 are again analysed for the merging scenario. On determining, that the two testing scenarios for nodes 410 and 412 have redundancy, the above process steps are repeated and the scenarios for 410 and 412 can be merged to create a new scenario that results in generation of merged node 414 to remove redundant data, thereby saving computing storage and computing resources.

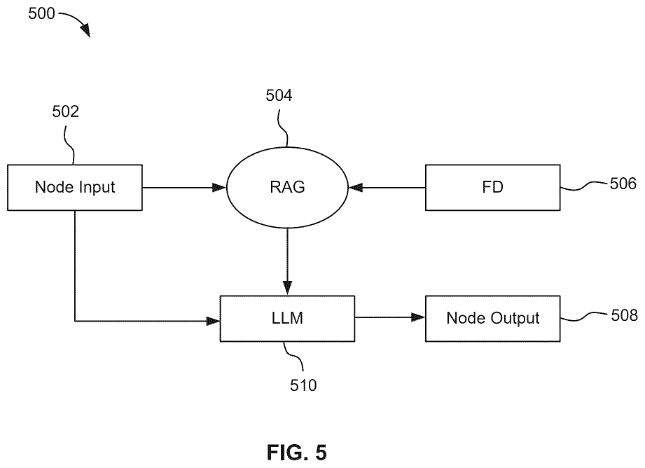

FIG. 5 illustrates a block diagram of a Retrieval-Augmented Generation (RAG) technique for Gen AI model, in accordance with the present disclosure.

FIG. 5 discloses the block diagram for the Retrieval-Augmented Generation (RAG) process that enhances the capability of Gen AI model 208, for example, may be LLM 348, by integrating an information retrieval system. The block diagram 500 discloses a node input 502, an FD/flat data 506, a node output 508, and a Gen AI model, for example Large Language Model or LLM 510 and A RAG 504.

The node input 502 received from a user as query and may be converted into an embedding, a numerical representation that captures the semantic meaning of the query. The FD 506 provides information retrieval by providing embeddings to search an external knowledge base or database to find relevant chunks of information. The RAG 504 retrieves information from the node input 502 and the FD 506, and then combine with the LLM 510 internal knowledge for augmentation. The augmentation helps the model to generate more accurate and contextually relevant responses. The LLM 510 uses the enriched information to generate the response as node output 508. This response is accurate and relevant because it is grounded in the retrieved data.

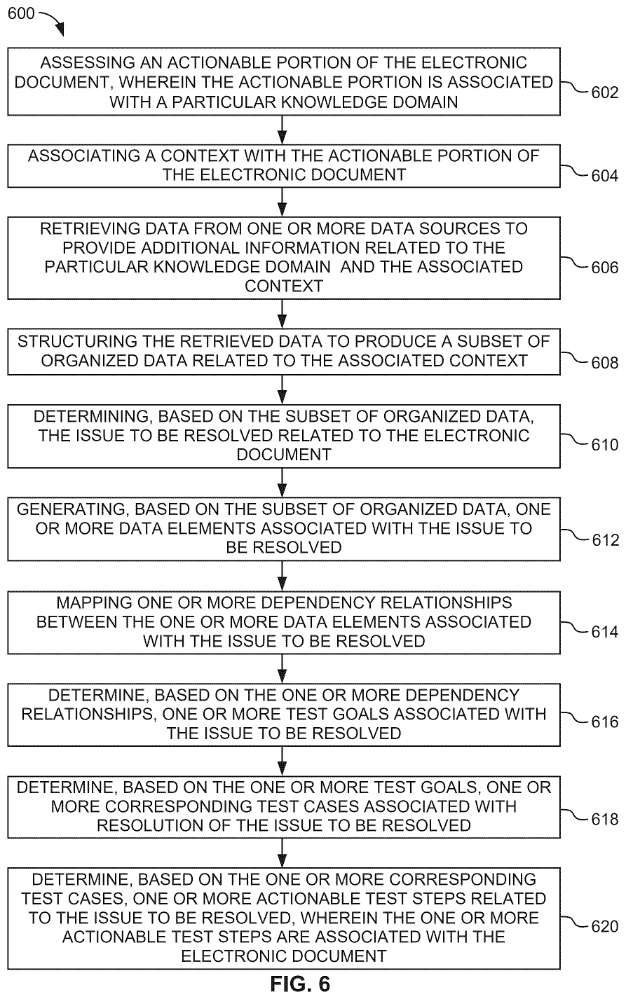

FIG. 6 illustrates an exemplary flow diagram for addressing an issue to be resolved associated with an electronic document, in accordance with present disclosure.

The method 600 addresses an issue to be resolved associated with an electronic document. The method discloses a step 602 to access an actionable portion of the electronic document, in which the actionable portion is associated with a particular knowledge domain. The actionable portion in the electronic document may be considered as the portion or the button or the information on which the action is required to be performed. For example, the electronic document may be considered as the user interface (UI) in which a user logs in a complaint. At step 604, the method discloses associating a context with the actionable portion of the electronic document. The complaint number 304 as actionable portion may be associated with context such as supplier, status, action and so on in the UI. At step 606, the method discloses retrieving data from one or more data sources to provide additional information related to the particular knowledge domain and the associated context. The processing of retrieved data from one or more data sources provides additional information related to the particular knowledge domain and the associated context. The data sources include but not limited to PRDs, functional design documents, user needs description documents, and workflow descriptions. At step 608, the method discloses structuring the retrieved data to produce a subset of organized data related to the associated context. The table 302 may be considered as structuring the retrieved data from different data sources to produce a subset of organised data related to the associated context. Thereafter, structure the retrieved data from the one or more data sources to produce a subset of organized data related to the associated context. At step 610, the method determines the issue to be resolved related to the electronic document based on the subset of organized data. The system discloses the issue to be resolved related to the electronic document, for example a particular complaint out of the group of complaints that may be selected to be solved based on the created subset. At step 612, the method discloses generating one or more data elements associated with the issue to be resolved based on the subset of organized data. Therefore, determining the data elements associated to the issue to be resolved may be considered for example buttons, list or different boxes available on UI to actuate the required action. At step 614, the method discloses mapping one or more dependency relationships between the one or more data elements associated with the issue to be resolved. At step 616, the method discloses determining one or more test goals associated with the issue to be resolved based on the one or more dependency relationships. The system 200 discloses that these test goals are generated based on the test scenario and for each test goal in the corresponding goals file. At step 618, the method discloses determining one or more corresponding test cases associated with resolution of the issue to be resolved, for example but not limited to the issue may be testing of search button or fetching particular complaint based on the search and so on. At step 620, the method discloses to determine one or more actionable test steps related to the issue to be resolved based on the one or more corresponding test cases. The one or more actionable test steps are associated with the electronic document. The generation of test steps may be considered as but not limited to generation of one or more user interface (UI) elements or one or more application programming interfaces (APIs) associated with the one or more actionable test steps related to the issue to be resolved. Further, the structuring of the data from the one or more data sources includes evaluating and discarding data that is incomplete, inapplicable, and of insufficient granularity as related to the issue to be resolved. Thereafter, utilizing the one or more actionable test steps in implementation of a testing scenario and updating the one or more actionable test steps according to results of the implementation of the testing scenario.

It should be appreciated that the Gen AI models as disclosed in the present disclosure are capable for complete coverage of input data, which is in the form of flat data, for example but not limited to user interface (UI), video, audio or any other different format. The Gen AI models as disclosed in the present invention generates the test cases automatically using flat data. Moreover, the Gen AI model disclosed herein covers almost all testing situations including handing input length limitation as well as complex user interfaces with nested elements and dynamic content. Moreover, the present disclosure discloses technique for providing information to Gen AI models in a comprehend manner and to increase input relevancy at each step, thereby reducing redundancy in the output. Accordingly, it solves complete test case coverage, accurately and to specific problems directly by using Gen AI models. The reduced redundancy saves computer resources, storages and generate output more efficiently.

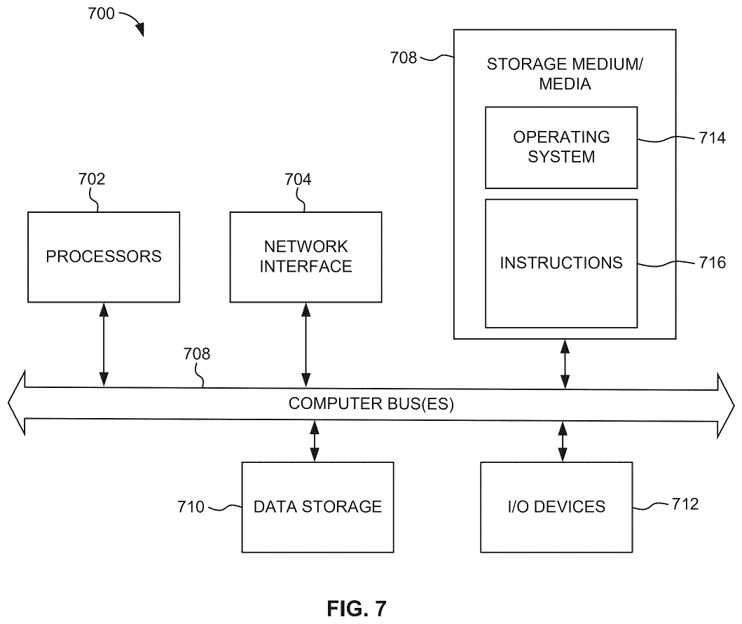

FIG. 7 illustrates a computer system 700 used for addressing an issue to be resolved associated with an electronic document. More particularly, computing machines such as desktops, laptops, smartphones, tablets, and wearables which may be used to store videos often have limited storage structure of the computer system 700. The computer system 700 may include additional components not shown and that some of the process components described may be removed and/or modified. In another example, a computer system 700 can sit on external-cloud platforms such as Amazon Web Services, AZURE® cloud or internal corporate cloud computing clusters, or organizational computing resources, etc.

The computer system 700 includes processor(s) 702, such as a central processing unit, ASIC or another type of processing circuit, input/output devices 712, such as a display, mouse keyboard, etc., a network interface 704, such as a Local Area Network (LAN), a wireless 802.11x LAN, a 3G or 4G mobile WAN or a WiMax WAN, and a processor-readable medium 706. Each of these components may be operatively coupled to a bus 708. The computer-readable medium 706 may be any suitable medium that participates in providing instructions to the processor(s) 702 for execution. For example, the processor-readable medium 706 may be non-transitory or non-volatile medium, such as a magnetic disk or solid-state non-volatile memory or volatile medium such as RAM. The instructions or modules stored on the processor-readable medium 706 may include machine-readable instructions 716 executed by the processor(s) 702 that cause the processor(s) 702 to perform the methods and functions of the system 200.

The system 200 may be implemented as software stored on a non-transitory processor-readable medium and executed by the processors 702. For example, the processor-readable medium 706 may store an operating system and code for the system 200. The operating system may be multi-user, multiprocessing, multitasking, multithreading, real-time, and the like. For example, during runtime, the operating system is running and the code for the system 200 is executed by the processor(s) 702.

The computer system 700 may include a data storage 710, which may include non-volatile data storage. The data storage 710 stores any data used by the video summarization system 200. The data storage 710 may be used to store information extracted from the user query and other data that is used by the system 200 during operation.

The network interface 704 connects the computer system 700 to internal systems for example, via a LAN. Also, the network interface 704 may connect the computer system to the Internet. For example, the computer system 700 may connect to web browsers and other external applications and systems via the network interface 704.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

What is claimed:

1. A method for addressing an issue to be resolved associated with an electronic document, the method comprising:
assessing an actionable portion of the electronic document, wherein the actionable portion is associated with a particular knowledge domain;
associating a context with the actionable portion of the electronic document;
retrieving data from one or more data sources to provide additional information related to the particular knowledge domain and the associated context;
structuring the retrieved data to produce a subset of organized data related to the associated context;
determining, based on the subset of organized data, the issue to be resolved related to the electronic document;
generating, based on the subset of organized data, one or more data elements associated with the issue to be resolved;
mapping one or more dependency relationships between the one or more data elements associated with the issue to be resolved;
determine, based on the one or more dependency relationships, one or more test goals associated with the issue to be resolved;
determine, based on the one or more test goals, one or more corresponding test cases associated with resolution of the issue to be resolved; and
determine, based on the one or more corresponding test cases, one or more actionable test steps related to the issue to be resolved, wherein the one or more actionable test steps are associated with the electronic document.

2. The method of claim 1, wherein determining the one or more actionable test steps related to the issue to be resolved includes generating a vector representation for each of the one or more actionable test steps.

3. The method of claim 2, further comprising calculating a distance between each vector representation of the one or more actionable test steps.

4. The method of claim 3, further comprising determining, based on a calculated distance between a vector representation of a first one of the one or more of the actionable test steps and a vector representation of a second one of the one or more of the actionable test steps, that the first one of the one or more of the actionable test steps and the second one of the one or more actionable test steps exceeds a similarity threshold, wherein the exceeding of the similarity threshold indicates a likelihood of redundancy.

5. The method of claim 4, further comprising merging the first one of the one or more of the actionable test steps and the second one of the one or more actionable test steps to eliminate a redundancy.

6. The method of claim 1, further comprising generating one or more user interface (UI) elements or one or more application programming interfaces (APIs) associated with the one or more actionable test steps related to the issue to be resolved.

7. The method of claim 1, wherein structuring the data from the one or more data sources includes evaluating and discarding data that is incomplete, inapplicable, and of insufficient granularity as related to the issue to be resolved.

8. The method of claim 1, further comprising:
utilizing the one or more actionable test steps in implementation of a testing scenario; and
updating the one or more actionable test steps according to results of the implementation of the testing scenario.

9. The method of claim 1, wherein the one or more data sources include product requirements documents (PRDs), functional design documents, user needs description documents, and workflow descriptions.

10. A non-transitory, computer-readable medium including machine-readable instructions that are executable by a processor to:
associating a context with an actionable portion of an electronic document, wherein the actionable portion is associated with a particular knowledge domain;
retrieving data from one or more data sources to provide additional information related to the particular knowledge domain and the associated context;
determining, based on the retrieved data, an issue to be resolved related to the electronic document;
determine, based on the issue to be resolved, one or more test goals associated with the issue to be resolved;
determine, based on the one or more test goals, one or more corresponding test cases associated with resolution of the issue to be resolved; and
determine, based on the one or more corresponding test cases, one or more actionable test steps related to the issue to be resolved, wherein the one or more actionable test steps are associated with the electronic document.

11. The non-transitory, computer-readable medium of claim 10, including instructions executable by the processor to further structure the data from the one or more data sources to produce a subset of organized data.

12. The non-transitory, computer-readable medium of claim 10, including instructions executable by the processor to:
generate one or more data elements associated with the issue to be resolved; and
map one or more dependency relationships between the one or more data elements associated with the issue to be resolved.

13. The non-transitory, computer-readable medium of claim 10, including instructions executable by the processor to further merge a first one of the one or more of the actionable test steps and a second one of the one or more actionable test steps to eliminate a redundancy.

14. The non-transitory, computer-readable medium of claim 10, including instructions executable by the processor to further generate one or more UI elements or one or more APIs associated with the one or more actionable test steps related to the issue to be resolved.

15. The non-transitory, computer-readable medium of claim 10, wherein the one or more data sources include PRDs, functional design documents, user needs description documents, and workflow descriptions.

16. A system comprising:
a processor;
a non-transitory memory device including machine-readable instructions that are executable by the processor to:
assess an actionable portion of an electronic document, wherein the actionable portion is associated with a particular knowledge domain;
associate a context with the actionable portion of the electronic document;
retrieve data from one or more data sources to provide additional information related to the particular knowledge domain and the associated context;
structure the retrieved data from the one or more data sources to produce a subset of organized data related to the associated context;
determine, based on the subset of organized data, an issue to be resolved related to the electronic document;
generate, based on the subset of organized data associated with the issue to be resolved, one or more data elements associated with the issue to be resolved; and
map one or more dependency relationships between the one or more data elements associated with the issue to be resolved.

17. The system of claim 16, wherein the non-transitory memory device further includes machine-readable instructions that are executable by the processor to determine, based on the one or more dependency relationships, one or more test goals associated with the issue to be resolved.

18. The system of claim 17, wherein the non-transitory memory device further includes machine-readable instructions that are executable by the processor to determine, based on the one or more test goals, one or more corresponding test cases associated with resolution of the issue to be resolved.

19. The system of claim 18, wherein the non-transitory memory device further includes machine-readable instructions that are executable by the processor to determine, based on the one or more corresponding test cases, one or more actionable test steps related to the issue to be resolved, wherein the one or more actionable test steps are associated with the electronic document.

20. The system of claim 16, wherein the one or more data sources include PRDs, functional design documents, user needs description documents, and workflow descriptions.
